(19) United States
(12) Patent Application Publication
(10) Pub. No.: US 2009/0037622 A1
(43) Pub. Date: Feb. 5, 2009

(54) Method and system for changing operation modes of an interface device

(75) Inventors: Dheeresh Dheeresh, San Diego, CA (US); Uday Sinha, San Diego, CA (US)

Correspondence Address: FARJAMI & FARJAMI LLP, 26522 LA ALAMEDA AVENUE, SUITE 360, MISSION VIEJO, CA, 92691, US

(73) Assignee: BROADCOM CORPORATION, IRVINE, CA (US)

(21) Appl. No.: 11/890,188

(22) Filed: Aug. 2, 2007

(51) Int. Cl. G06F 13/12

(52) U.S. Cl. 710/63

(57) ABSTRACT

There is provided a system for use in a Universal Serial Bus (“USB”) device to enable switching of a mode of operation of the USB device while maintaining a physical USB connection to a host device. According to one embodiment, the system includes a port coupled to the host device via a physical USB connection. The system further includes a USB module coupled to the port via a number of USB bus lines. One of the number of USB bus lines may be coupled to the port through a tristate device. The tristate device is configured to electrically disconnect the one of the number of USB bus lines from the host device and to electrically reconnect the one of the number of USB bus lines to the host device.

### BACKGROUND OF THE INVENTION

1. Field of the Invention

The present invention relates generally to interface devices. More particularly, the present invention relates to Universal Serial Bus (“USB”) peripheral devices.

2. Background Art

Electronic devices capable of communicating via a Universal Serial Bus (“USB”) protocol (herein referred to as “USB devices”), such as cellular telephones and MP3 players, can have one or more possible modes of operation. For example, a USB device can operate in a mass storage class mode, a serial communication interface mode, or a media transfer protocol (“MTP”) interface mode. Accordingly, once a USB device is connected to a host device via a USB cable, the selected or default mode of operation of the USB device is obtained by the host device (e.g., during a detection process) and the appropriate drivers associated with that mode of operation is loaded in the host device to enable communication over the USB cable.

However, today, in order to switch a current mode of operation of a client USB device to a new mode, a user must physically disconnect the USB cable connecting the USB device to the host. Thereafter, the USB device is configured to operate in a new mode of operation, which requires the loading or configuring a driver by the client device. Then again, the USB cable must be physically reconnected to the host device. After reconnecting the USB cable, client mode of operation is obtained to enable the host device to operate in the new mode of operation. Thus, each time a mode of operation of a conventional USB device is to be switched or changed, the user is disadvantageously required to physically disconnect and then reconnect the USB cable, which is very inconvenient and impedes automated switching of mode of operation of the client device.

### SUMMARY OF THE INVENTION

There is provided methods and systems for changing operation modes of a USB device, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 illustrates a diagram of a conventional USB system;

FIG. 2 illustrates a block diagram of the conventional USB system of FIG. 1;

FIG. 3 illustrates a block diagram of a system for use in a USB device to enable switching of a mode of operation of the USB device while maintaining a physical USB connection to a host device, in accordance with one embodiment of the present invention; and

FIG. 4 illustrates a flowchart of a method for use by a USB device for switching a mode of operation of the USB device while maintaining a physical USB connection to a host device, in accordance with one embodiment of the invention.

### DETAILED DESCRIPTION OF THE INVENTION

Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely example embodiments of the invention. To maintain brevity, other embodiments of the invention which use the principles of the present invention are not specifically described in the present application and are not specifically illustrated by the present drawings. It should be borne in mind that, unless noted otherwise, like or corresponding elements among the figures may be indicated by like or corresponding reference numerals.

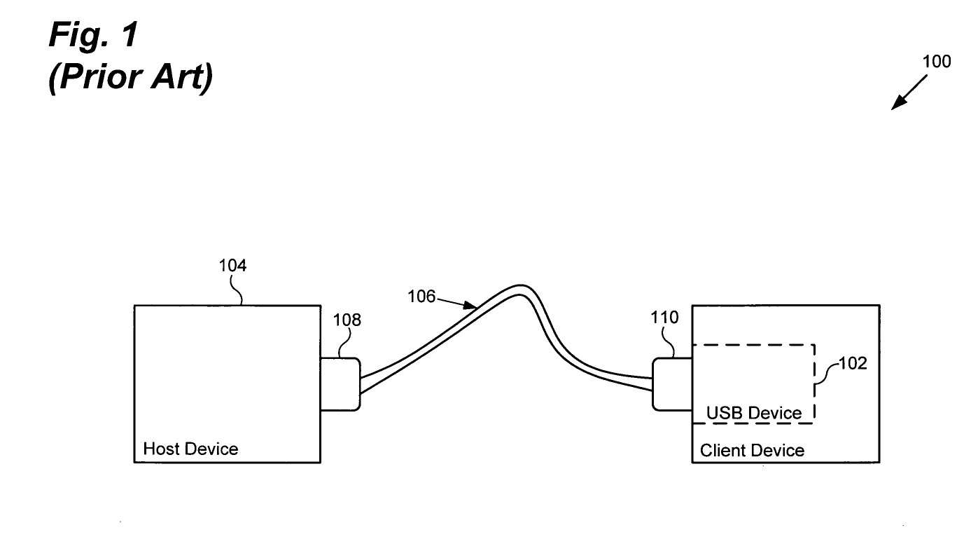

FIG. 1 illustrates a diagram of conventional USB system 100, which includes USB device 102, host device 104, and USB cable 106. As shown in FIG. 1, USB device 102 is connected to host device 104 via USB cable 106, which includes connectors 108 and 110. Client device, including USB device 102, can be, for example, any electronic device capable of communicating via a USB protocol, such as a cellular telephone, an MP3 player, a USB flash drive (also referred to in the art as a “pen drive”), a personal digital assistant (“PDA”), a digital camera, or a printer. Host device 104 can be, for example, a personal computer. In FIG. 1, USB cable 106 provides both a physical and electrical connection between USB device 102 and host device 104.

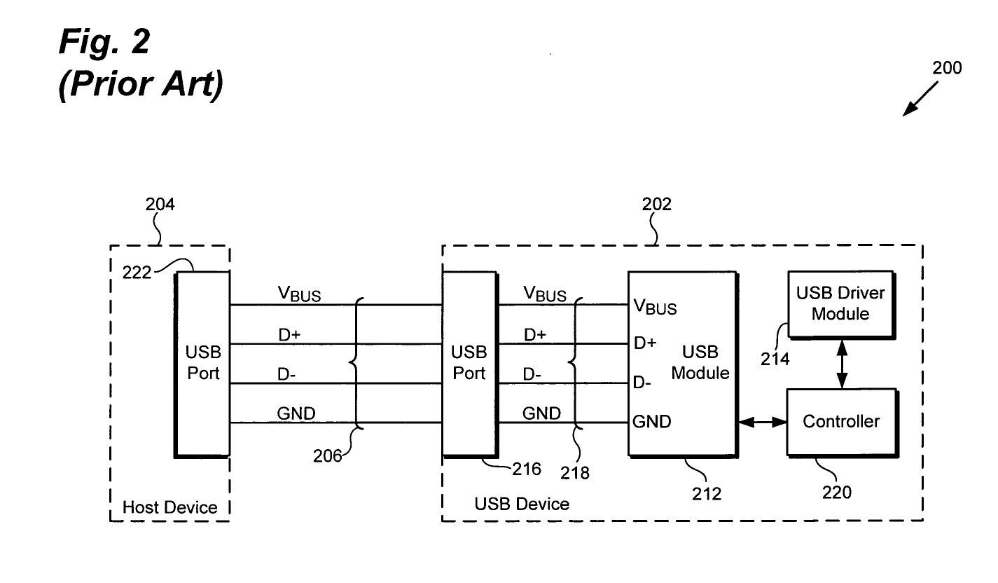

FIG. 2 shows a block diagram of system 100 shown in FIG. 1. System 200 includes USB device 202, contained within a client device, and host device 204. As shown in FIG. 2, USB device 202 includes USB module 212, controller 220, USB driver module 214, and USB port 216. As also shown in FIG. 2, host device 204 includes USB port 222. For example, port 216 can be a type-B USB receptacle and port 222 can be a type-A USB receptacle. USB device 202 and host device 204 in FIG. 2 correspond to USB device 102 and host device 104 in FIG. 1, respectively.

As shown in FIG. 2, USB module 212 is coupled to port 216 by USB bus lines 218. As shown in FIG. 2, USB bus lines 218 includes a voltage bus line (“V_{BUS}”), data lines (“D+” and “D−”), and a ground line (“GND”). USB module 212 includes a USB controller and a USB transceiver, USB module 212 is coupled to controller 220. Controller 220 can be, for example, a microcontroller. As also shown in FIG. 2, USB driver module 214 is coupled to controller 220. As discussed further below, USB driver module 214 is a system software with a programming interface for user application to configure USB device 202 and operate USB device 202 in different modes. As further shown in FIG. 2, USB bus lines 218 are coupled to port 222 of host device 204 via USB bus lines 206. USB bus lines 206 can reside in a conventional USB cable, such as USB cable 106 in FIG. 1.

By way of background, when host device 204 and USB device 202 are initially connected together with a USB cable (e.g., USB cable 106 in FIG. 1), upon connecting the USB cable with powered host device 204, the host device 204 detects bus connectivity as a result of voltage presence on the bus line. As is known in the art, a USB device can have one or more possible modes of operation, such as a mass storage interface mode, a serial communication interface mode, or a media transfer protocol (“MTP”) interface mode.

However, to switch between the possible modes of operation of USB device 202, USB bus lines 206 must first be disconnected by physically disconnecting the USB cable (e.g., USB cable 106 in FIG. 1). Then, USB device 202 must be reconfigured to operate in a new mode of operation. Thereafter, the USB cable must be reconnected to USB device 202 and host device 204. After reconnecting the USB cable, the bus connectivity is detected as described above, thereby allowing USB device 202 to operate in a new mode of operation.

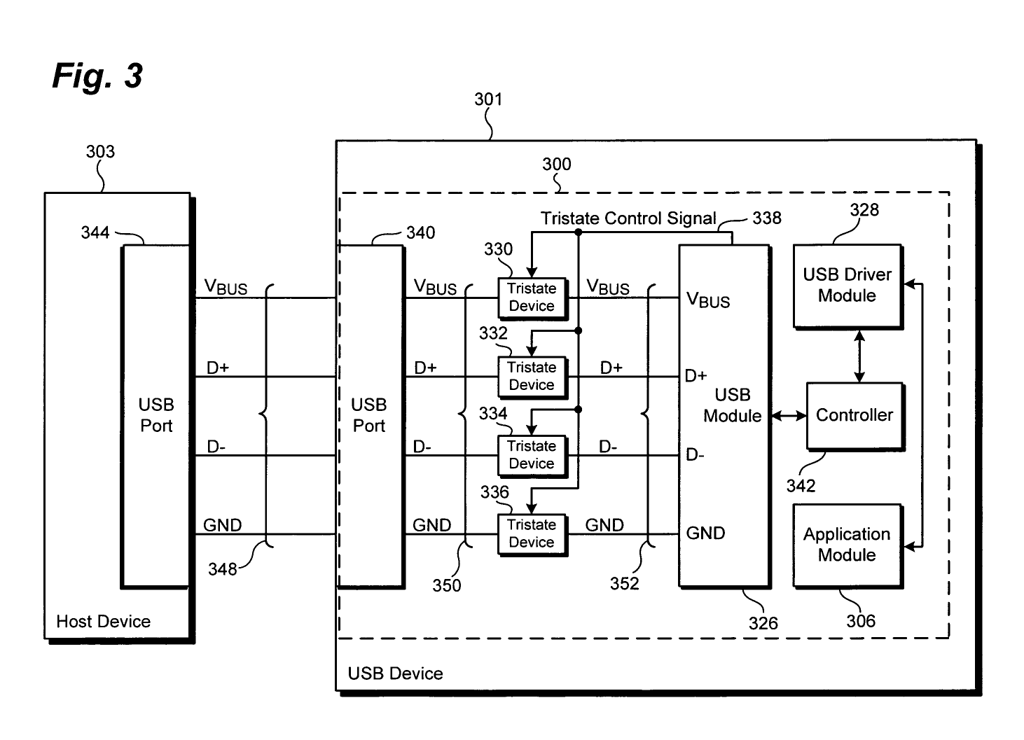

FIG. 3 shows a block diagram of a system for use in a USB device to enable switching of a mode of operation of the USB device while maintaining a physical USB connection to a host device. System 300 in FIG. 3 can be implemented in USB device 301, which includes USB module 326, controller 342, USB driver module 328, application module 306, tristate devices 330, 332, 334, and 336 (also referred to as “tristate devices 330 through 336”), and port 340. As shown in FIG. 3, USB device 301 is connected to host device 303, which includes port 344. USB device 301 can be, for example, any electronic device capable of communicating via a USB protocol, such as a cellular telephone, an MP3 player, a USB flash drive (also referred to in the art as a “pen drive”), a personal digital assistant (“PDA”), a digital camera, or a printer. Host device 303 can be any host USB device, for example, host USB device on a personal computer or a portable device

As shown in FIG. 3, USB module 326 is connected to port 340 through USB bus lines 352, respective tristate devices 330 through 336, and USB bus lines 350. In one embodiment, each of tristate devices 330 through 336 can be implemented using a tristatable bidirectional buffer. In another embodiment, each of tristate devices 330 through 336 can be implemented using an electronic switch. As shown in FIG. 3, USB bus lines 350 and 352 each include a corresponding voltage bus line (“V_{BUS}”), corresponding data lines (“D+” and “D−”), and a corresponding ground line (“GND”). In the embodiment shown in FIG. 3, each of USB bus lines 352 is coupled to a first terminal of a respective tristate device. For example, V_{BUS} in USB bus lines 352 is coupled to a first terminal of tristate device 330 and data line D+ in USB bus lines 352 is coupled to a first terminal of tristate device 332. As shown in FIG. 3, each of USB bus lines 350 is coupled to a second terminal of a respective tristate device. For example, V_{BUS} in USB bus lines 350 can be connected or disconnected to a second terminal of tristate device 330 by applying tristate control signal 338, and data line D+ in USB bus lines 350 is connected to a second terminal of tristate device 332. Thus, each tristate device in system 300 can be electrically connected or electrically disconnected by applying tristate control signal 338 to the corresponding V_{BUS}, D+, D−, or GND lines in USB bus lines 350 and 352. In the embodiment shown in FIG. 3, USB bus lines 350 are coupled to port 344 of host device 303 via USB bus lines 348. USB bus lines 348 can reside, for example, in a USB cable connecting USB device 301 to host device 303.

In the embodiment shown in FIG. 3, USB module 326 and USB driver module 328 are both connected to controller 342. Controller 342 can be, for example, a microcontroller. As shown in FIG. 3, USB module 326 can be controlled to output tristate control signal 338, which can enable or disable each of tristate devices 330 through 336 at a respective control input. Tristate control signal 338 can be, for example, a low or high voltage level depending on the device voltage level.

An example operation of system 300 will now be discussed. Upon connecting USB device 301 to host device 303 with a USB cable and powering on USB device 301, USB module 326 configures tristate control signal 338 to an appropriate logic value that enables each of tristate devices 330 through 336 to electrically connect the corresponding V_{BUS}, D+, D−, and GND lines in USB bus lines 350 and 352. In other words, each of tristate devices 330 through 336 is configured to allow the passing of electrical signals from its first terminal to its second terminal or from its second terminal to its first terminal. Consequently, a detection process can be initiated where USB module 326 detects a voltage output by host device 303 on V_{BUS}. Upon detecting the voltage on V_{BUS}, USB module 326 transmits a communication to host device 303 on either data line D+ or D−, thereby indicating to host device 303 that USB device 301 is connected to host device 303. Thereafter, USB module 326 transmits a communication to host device 303 indicating a selected or default mode of operation (also referred to in the art as “device class information”) of USB device 301. USB driver module 328 then loads the appropriate drivers associated with that mode of operation. As previously discussed, a USB device can have one or more possible modes of operation, such as a mass storage interface mode, a serial communication interface mode, or a media transfer protocol (“MTP”) interface mode. After the mode of operation of USB device 301 is transmitted to host device 303, the appropriate drivers are loaded in host device 303 to enable communication over the connected USB cable (i.e., USB bus lines 348).

To switch the mode of operation of USB device 301, USB module 326 can be controlled to set tristate control signal 338 to an appropriate value to cause each of tristate devices 330 through 336 to operate in a connected or disconnected mode. A disconnected mode of a tristate device provides high electrical impedance to the connecting lines. In one embodiment, tristate control signal 338 is controlled by a USB driver in USB driver module 328, which can be controlled by application module 306. Thus, each of tristate devices 330 through 336 can be controlled to establish electrical connection or disconnection from its first terminal to its second terminal, or from its second terminal to its first terminal. As such, due to the high impedance created by each of tristate devices 330 through 336, the corresponding V_{BUS}, D+, D−, and GND lines in USB bus lines 350 and 352 are, in effect, electrically disconnected from on another. As a result, USB device 301 is also electrically disconnected from host device 303, while advantageously maintaining a physical USB cable connection with host device 303 via the USB cable (i.e., USB bus lines 348). Thus, the above-described embodiment allows a USB device that is coupled to a host device via a USB cable to be electrically disconnected from the host device, without having to physically disconnect the USB cable.

Once USB device 301 is electrically disconnected from host device 303 as described above, application module 306 can be configured to switch the mode of operation of USB device 301. Application module 306 can be implemented, for example, in either software or hardware. In other embodiments, application module 306 can be situated in host device 303, thereby allowing host device 303 to switch the mode of operation of USB device 301 remotely. Once a new mode of operation has been selected by application module 306, the appropriate drivers associated with the new mode of operation can be loaded by application module 306. Thereafter, USB module 326 can set tristate control signal 338 to an appropriate logic value that enables each of tristate devices 330 through 336 to electrically reconnect the corresponding V_{BUS}, D+, D−, and GND lines in USB bus lines 350 and 352. The detection process discussed above can then be repeated, thereby allowing USB device 301 to begin operating in the new mode of operation.

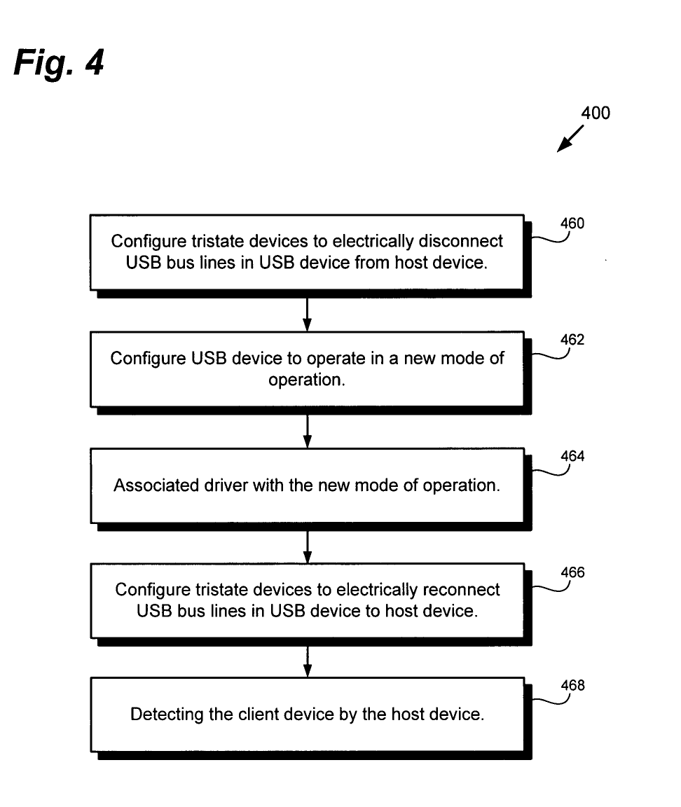

FIG. 4 illustrates flowchart 400 for performing an example method for use by a USB device for switching a mode of operation of said USB device while maintaining a physical USB connection to a host device. With reference to the embodiment of the invention shown in FIG. 3 and as shown in FIG. 4, at step 460 of flowchart 400, tristate devices 330 through 336 are configured to operate in a high impedance mode to electrically disconnect USB bus lines 352 from host device 303. Then, at step 462, USB device 301 is configured to operate in a new mode of operation. At step 464, a driver is associated with the new mode of operation. At step 466, tristate devices 330 through 336 are enabled to electrically reconnect USB bus lines 352 to host device 303. Then, at step 468, host device 303 detects USB device 301.

Thus, an embodiment of the present invention enables a USB device to switch between modes of operation (e.g., a mass storage interface mode or a serial communication interface mode) of the USB device while maintaining a physical USB connection to a host device. As such, a USB device can be conveniently reconfigured to operate in a new mode of operation without requiring a user of the USB device to physically disconnect and reconnect the USB cable connected between the USB device and the host device. Moreover, since aspects of the present invention can be integrated into existing USB architectures by including one or more tristate devices (e.g., tristate devices 330 through 336) and providing for a tristate control signal (e.g., tristate control signal 338), the USB devices can be conveniently implemented at a low cost. Further, although the present invention is described in conjunction with USB devices, the present invention is not limited to USB and may equally be applied to other interconnect or interface buses.

From the above description of the invention it is manifest that various techniques can be used for implementing the concepts of the present invention without departing from its scope. Moreover, while the invention has been described with specific reference to certain embodiments, a person of ordinary skill in the art would recognize that changes could be made in form and detail without departing from the spirit and the scope of the invention. For example, it is contemplated that the circuitry disclosed herein can be implemented in software, or vice versa. The described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A system for use in a Universal Serial Bus (USB) device to enable switching between modes of operation of said USB device while maintaining a physical USB connection to a host device, said system comprising:
a port coupled to said host device via said physical USB connection;
a USB module coupled to said port via a plurality of USB bus lines;
a tristate device, wherein one of said plurality of USB bus lines is coupled to said port through said tristate device, said tristate device being configured to electrically disconnect said one of said plurality of USB bus lines from said host device and to electrically reconnect said one of said plurality of USB bus lines to said host device.

2. The system of claim 1 wherein said tristate device is configured to receive a tristate control signal at a control input of said tristate device.

3. The system of claim 2 wherein said USB module provides said tristate control signal.

4. The system of claim 1 further comprising a USB driver module configured to store one or more drivers of said USB device.

5. The system of claim 1 further comprising an application module, wherein said application module is used to configure said USB device to operate in a new mode of operation after said one of said plurality of bus lines is electrically disconnected from said host device.

6. The system of claim 1 wherein said mode of operation is one of a mass storage interface mode, a media transfer protocol (“MTP”) interface mode, or a serial communication interface mode.

7. The system of claim 1 wherein said USB device is one of a cellular telephone, an MP3 player, a USB flash drive, a personal digital assistant (“PDA”), a digital camera, or a printer.

8. A method for use by a Universal Serial Bus (USB) device for switching a mode of operation of said USB device while maintaining a physical USB connection to a host device, wherein said USB device includes a USB module coupled to a port via a plurality of USB bus lines, wherein said USB bus lines are coupled to said port through a plurality of respective tristate devices, said method comprising:
configuring said plurality of tristate devices to electrically disconnect said USB bus lines from said host device;
configuring said USB device to operate in a new mode of operation;
loading a driver associated with said new mode of operation from a USB driver module;
configuring said plurality of tristate devices to electrically reconnect said USB bus lines to said host device;
initiating a detection process with said host device.

9. The method of claim 8 wherein said plurality of tristate devices are controlled by a tristate control signal provided by said USB module.

10. The method of claim 8 wherein said configuring said USB device to operate in said new mode of operation is performed by an application module.

11. The method of claim 10 wherein said application module is included in said USB device.

12. The method of claim 8 wherein said USB driver module is configured to store one or more drivers of said USB device.

13. The method of claim 8 wherein said mode of operation is one of a mass storage interface mode, a media transfer protocol (“MTP”) interface mode, or a serial communication interface mode.

14. The method of claim 8 wherein said USB device is one of a cellular telephone, an MP3 player, a USB flash drive, a personal digital assistant (“PDA”), a digital camera, or a printer.

15. A method for use by a device for switching a mode of operation of said device while maintaining a physical connection to a host device, wherein said device includes a device module coupled to a port via a plurality of bus lines, wherein said bus lines are coupled to said port through a plurality of respective tristate devices, said method comprising:
configuring said plurality of tristate devices to electrically disconnect said bus lines from said host device;
configuring said device to operate in a new mode of operation;
loading a driver associated with said new mode of operation from a driver module;
configuring said plurality of tristate devices to electrically reconnect said bus lines to said host device;
initiating a detection process with said host device.

16. The method of claim 15 wherein said plurality of tristate devices are controlled by a tristate control signal provided by said device module.

17. The method of claim 15 wherein said configuring said device to operate in said new mode of operation is performed by an application module.

18. The method of claim 17 wherein said application module is included in said device.

19. The method of claim 15 wherein said driver module is configured to store one or more drivers of said device.

20. The method of claim 15 wherein said device is one of a cellular telephone, an MP3 player, a flash drive, a personal digital assistant (“PDA”), a digital camera, or a printer.
